(19) United States
(12) Patent Application Publication
(10) Pub. No.: US 2024/0428084 A1
(43) Pub. Date: Dec. 26, 2024

(54) REINFORCEMENT MACHINE LEARNING WITH HYPERPARAMETER TUNING

(71) Applicant: International Business Machines Corporation, Armonk, NY (US)

(72) Inventors: Elita Astrid Angelina Lobo, Middletown, CT (US); Nhan Huu Pham, Tarrytown, NY (US); Dharmashankar Subramanian, RYE BROOK, NY (US); Tejaswini Pedapati, White Plains, NY (US)

(21) Appl. No.: 18/340,457

(22) Filed: Jun. 23, 2023

(51) Int. Cl. G06N 3/0985; G06N 3/0455

(52) U.S. Cl. CPC G06N 3/0985; G06N 3/0455

(57) ABSTRACT

According to a present invention embodiment, a system for training a reinforcement learning agent comprises one or more memories and at least one processor coupled to the one or more memories. The system trains a machine learning model based on training data to generate a set of hyperparameters for training the reinforcement learning agent. The training data includes encoded information from hyperparameter tuning sessions for a plurality of different reinforcement learning environments and reinforcement learning agents. The machine learning model determines the set of hyperparameters for training the reinforcement learning agent, and the reinforcement learning agent is trained according to the set of hyperparameters. The machine learning model adjusts the set of hyperparameters based on information from testing of the reinforcement learning agent. Embodiments of the present invention further include a method and computer program product for training a reinforcement learning agent in substantially the same manner described above.

### BACKGROUND

### 1. Technical Field

Present invention embodiments relate to machine learning, and more specifically, to reinforcement machine learning or reinforcement learning (RL) with tuning of hyperparameters based on a sequence model.

### 2. Discussion of the Related Art

Reinforcement learning (RL) agents are deployed in dynamic environments. Examples of RL agents include conversational agents or chatbots, online shopping software agents, spam filters, etc. Rather than being programmed to execute a series of tasks, these agents are configured to act autonomously in order to reach a desired goal. Reinforcement learning (RL) is based on interaction between an environment and an RL agent. A current state of the environment and reward is received, and an action is selected by the RL agent and performed. The environment transitions to a new state based on the action, and the reward associated with the transition is determined. Reinforcement learning (RL) determines a manner that maximizes the reward. In other words, the reinforcement learning rewards accurate decisions and penalizes for failures or incorrect decisions.

Tuning of hyperparameters for reinforcement learning (RL) is challenging, and requires extensive computational resources. Many hyperparameter tuning approaches do not leverage knowledge from prior hyperparameter tuning experiences. These experiences may be available from tuning RL agents on a wide range of environments with different RL techniques. As a result, these approaches are sample inefficient. Moreover, hyperparameter tuning approaches that do not leverage prior knowledge to predict hyperparameters are agnostic to the current stage of training of the RL agent and, thus, can be slower in achieving optimal performance.

### SUMMARY

According to one embodiment of the present invention, a system for training a reinforcement learning agent comprises one or more memories and at least one processor coupled to the one or more memories. The system trains a machine learning model based on training data to generate a set of hyperparameters for training the reinforcement learning agent. The training data includes encoded information from hyperparameter tuning sessions for a plurality of different reinforcement learning environments and reinforcement learning agents. The machine learning model determines the set of hyperparameters for training the reinforcement learning agent, and the reinforcement learning agent is trained according to the set of hyperparameters. The machine learning model adjusts the set of hyperparameters based on information from testing of the reinforcement learning agent. Embodiments of the present invention further include a method and computer program product for training a reinforcement learning agent in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a diagrammatic illustration of a system for tuning hyperparameters of reinforcement learning (RL) for training an RL agent according to an embodiment of the present invention.

FIG. 3 is flow diagram of a manner of tuning hyperparameters of reinforcement learning (RL) for training an RL agent according to an embodiment of the present invention.

FIG. 4 is a flow diagram of encoding rollouts of environments and reinforcement learning (RL) agents according to an embodiment of the present invention.

FIG. 5 is a flow diagram of preprocessing rollouts for training a meta-tuning agent to produce hyperparameters for training a reinforcement learning (RL) agent according to an embodiment of the present invention.

FIG. 6 is a flow diagram of using preprocessed rollouts to train a meta-tuning agent according to an embodiment of the present invention.

FIG. 7 is a flow diagram of evaluating a meta-tuning agent generating hyperparameters for reinforcement learning (RL) according to an embodiment of the present invention.

FIG. 8 shows graphical illustrations of results of hyperparameter tuning by an embodiment of the present invention relative to conventional techniques.

FIG. 9 shows graphical illustrations of further results of hyperparameter tuning by an embodiment of the present invention relative to conventional techniques.

### DETAILED DESCRIPTION

Reinforcement learning (RL) agents are deployed in dynamic environments. Examples of RL agents include conversational agents or chatbots, online shopping software agents, spam filters, etc. Rather than being programmed to execute a series of tasks, these agents are configured to act autonomously in order to reach a desired goal. Reinforcement learning (RL) is based on interaction between an environment and an RL agent. A current state of the environment and a reward is received, and an action is selected by the RL agent and performed. The environment transitions to a new state based on the action, and the reward associated with the transition is determined. Reinforcement learning (RL) determines a manner that maximizes the reward. In other words, the reinforcement learning rewards accurate decisions and penalizes for failures or incorrect decisions.

Tuning of hyperparameters for reinforcement learning (RL) is challenging, and requires extensive computational resources. Many hyperparameter tuning approaches do not leverage knowledge from prior hyperparameter tuning experiences. These experiences may be available from tuning RL agents on a wide range of environments with different RL techniques. As a result, these approaches are sample inefficient. Moreover, hyperparameter tuning approaches that do not leverage prior knowledge to predict hyperparameters are agnostic to the current stage of training of the RL agent and, thus, can be slower in achieving optimal performance.

Accordingly, an embodiment of the present invention exploits existing useful patterns in a hyperparameter search space of different reinforcement learning (RL) agents and environments that can be learned from prior hyperparameter tuning experiences. Models that learn these patterns are used for recommending effective initial hyperparameters for any new RL environment and agent, thereby severely reducing the computational costs that come with tuning any new RL agent in a new environment. Further, the models also recommend how to dynamically tune and modify these hyperparameters while progress is made on training the chosen RL agent against the chosen environment.

The meta-hyperparameter tuning of present invention embodiments is based on historical tuning experiences expressed as an offline reinforcement learning function or equation, and a meta-tuning agent is trained to predict hyperparameters. The meta-tuning agent observes a current state of a reinforcement learning (RL) agent, and chooses the next set of hyperparameters to either initialize (or warm-start) or further dynamically tune the RL agent. A reward signal for the meta-tuning agent is the performance (e.g., discounted summation of rewards in the environment, etc.) attained by the RL agent on training with the hyperparameters selected by the meta-tuning agent.

An embodiment of the present invention provides a meta-hyperparameter tuning system which can learn from existing tuning experiences in an offline reinforcement learning (RL) setting. The meta-hyperparameter tuning system uses existing hyperparameter tuning experiences to train an agent for reinforcement machine learning or reinforcement learning (RL). The meta-hyperparameter tuning system trains a meta-tuning agent on historical meta-tuning data so that the meta-tuning agent produces effective hyperparameters on the fly for any new RL agent and environment, and further dynamically tunes these choices at any given stage of training.

An embodiment of the present invention uses prior hyperparameter tuning experiences collected from different reinforcement learning (RL) environments and RL agents (RL techniques) to train an offline meta-tuning agent that dynamically suggests hyperparameters based on a current state of the RL techniques. The embodiment captures and uses information about the RL agent policy, reward function, and environment dynamics via encodings of rollouts to predict hyperparameters for the RL agent at any stage of training. An autoencoder encodes rollouts that natively include information about the policy (that produces rollouts), reward, and system dynamics, where the encoding is preferably produced as a fixed-length vector encoding. The encodings may be ranked based on total rewards, and encodings of specific quantiles of rollouts may be selected and concatenated to produce a final encoding. A meta-tuning agent may be trained using any offline reinforcement learning (RL) technique to produce hyperparameters for training an RL agent.

A meta-hyperparameter tuning framework of a present invention embodiment is agnostic to structures of reinforcement learning (RL) techniques and environments, and thus, can be used directly with any existing or new RL technique on any environment.

The meta-hyperparameter tuning framework of a present invention embodiment is well-suited for systems, such as Automated Reinforcement Learning, that naturally accumulate significant amounts of prior tuning experiences using standard tuning techniques, such as population based training (PBT) and hyperopt based tuning of reinforcement learning (RL) agents. However, the meta-hyperparameter tuning framework investigates meta-hyperparameter tuning in the context of reinforcement learning (RL) and produces effective hyperparameters as a solution to an offline RL expression.

The meta-hyperparameter tuning framework of a present invention embodiment predicts hyperparameters at any stage of training of a reinforcement learning (RL) agent. In addition, the meta-hyperparameter tuning framework uses environment and policy information via rollout encodings. These encodings capture information about a state of the RL agent and facilitate prediction of hyperparameters for an RL agent at any stage of training.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

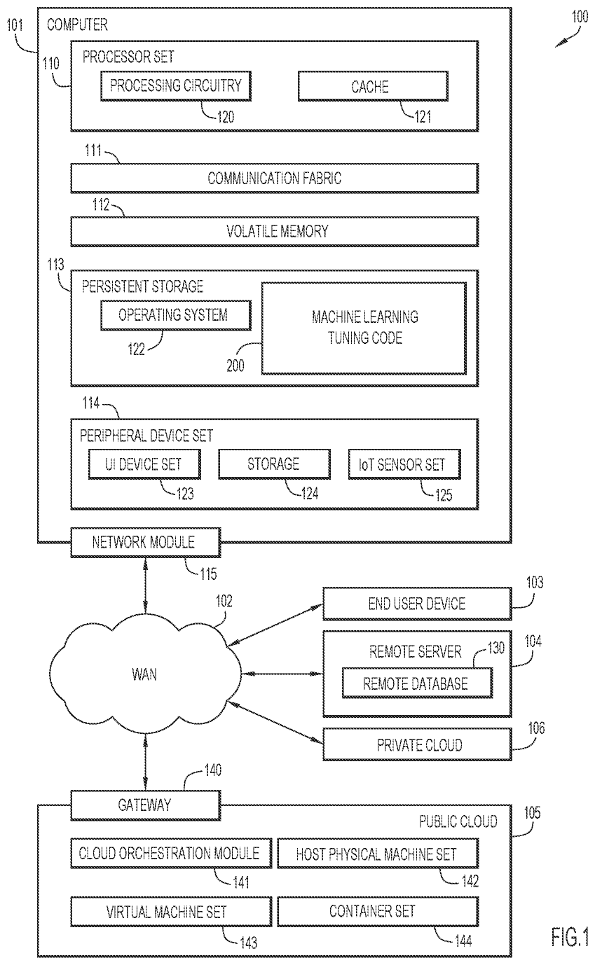

Referring to FIG. 1, computing environment 100 contains an example of an environment for the execution of at least some of the computer code involved in performing the inventive methods, such as machine learning tuning code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

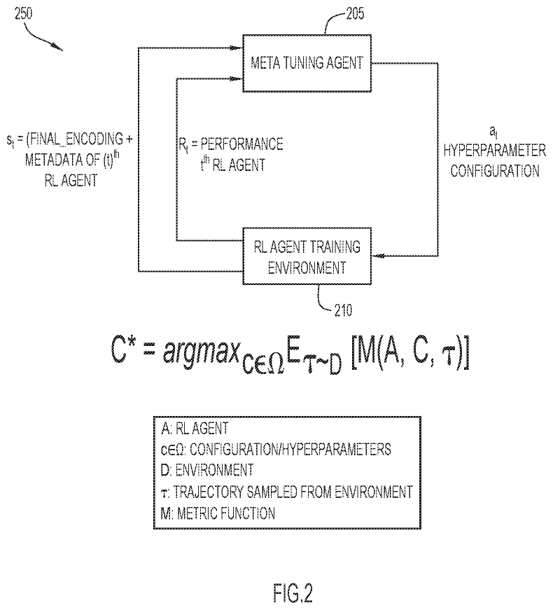

A system 250 for tuning hyperparameters of reinforcement learning (RL) for training an RL agent according to an embodiment of the present invention is illustrated in FIG. 2. Initially, system 250 may be implemented by computer 101 and machine learning tuning code 200, and includes a meta-tuning agent 205 and a training environment 210. Meta-tuning agent 205 is trained to produce hyperparameters for reinforcement learning (RL) for training an RL agent as described below. The hyperparameters may include any quantity of any type of hyperparameters that configure or control the reinforcement learning (RL) of an RL agent, such as epsilon (e.g., how often an RL agent explores and exploits), learning rate (e.g., rate of learning from new states of experience), discount factor (e.g., amount of contribution of future rewards for an expected reward), model architecture of the policy or value functions, generalized advantage estimation (GAE) lambda, clip range, entropy coefficient for loss calculation, etc. The hyperparameters are provided to training environment 210 for training the RL agent based on performing reinforcement learning (RL) according to the hyperparameters. Meta-tuning agent 205 preferably employs reinforcement learning (RL), and generates the hyperparameters as an action based on a state of the RL agent and a reward produced by training environment 210. The state of the RL agent corresponds to an encoding pertaining to environment and agent information, while the reward corresponds to the performance of the RL agent in an environment (e.g., accuracy, number of decisions or iterations to reach a desired goal, etc.). The hyperparameters are repeatedly adjusted by meta-tuning agent 205 based on the resulting state and reward of the RL agent from training environment 210 for a configurable or predetermined number of iterations in order to train the RL agent to maximize the reward. The hyperparameter optimization may be expressed with respect to an argmax function to find the optimal set of hyperparameters producing the greatest value of a specific metric function M (e.g., determining performance of the RL agent, etc.) with respect to the inputs (e.g., RL agent (A), hyperparameter configuration (C), and environment trajectory (τ) (e.g., state, action, and reward of the RL agent in an environment over a time interval)) as shown in FIG. 2. Present invention embodiments provide better or similar performance relative to those of conventional techniques (e.g., grid search/random search, evolution strategies, gradient-based optimization, Bayesian optimization, etc.) with fewer trials or iterations as described below. Once trained, the RL agent may be deployed in a target environment.

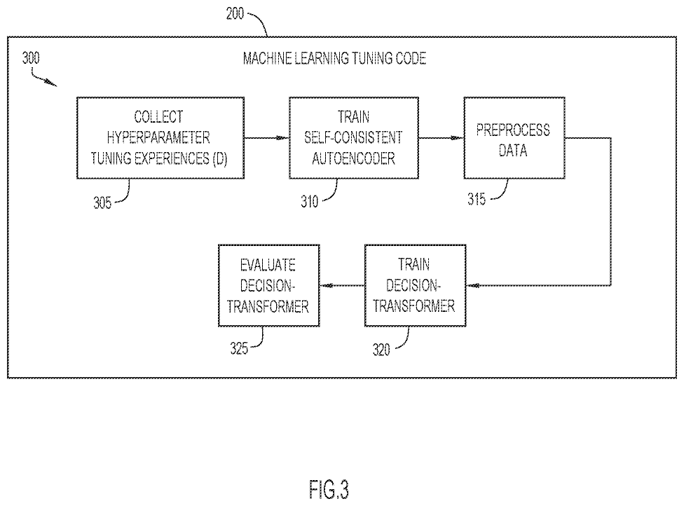

A method 300 of tuning hyperparameters of reinforcement learning (RL) for training an RL agent (e.g., via machine learning tuning code 200 and computer 101, etc.) according to an embodiment of the present invention is illustrated in FIG. 3. Initially, in order to train a meta-tuning agent, existing hyperparameter optimization techniques are used to collect hyperparameter tuning sessions or experiences for different environments.

In particular, machine learning tuning code 200 collects or generates a set of hyperparameter tuning experiences or sessions (e.g., D as viewed in FIG. 3) at operation 305. The tuning experiences or sessions basically represent determination (or tuning) of hyperparameters for reinforcement learning (RL) based on an RL agent operating (and/or training) within an environment and a corresponding conventional or other tuning technique or model. A performance metric may be obtained for the RL agent in the environment during the tuning. A tuning experience or session may be expressed by a batch or set of T transition tuples (e.g., where T≥1, and each transition tuple corresponds to a time step, t, from 1 . . . T). Each transition tuple indicates the environment, RL agent, hyperparameters employed, and performance metric (e.g., accuracy, number of decisions or iterations to reach a desired goal, etc.) for the RL agent, and may be of the form <(environment, reinforcement learning (RL) agent), hyperparameters, performance metric)>. The set of transition tuples collected at time step 1 until time step T corresponds to an episode, where each time step corresponds to an event for which a new set of hyperparameters is generated (including the special case when the hyperparameters are unchanged). In other words, each transition tuple or record in the sequence may be expressed as follows: <(environment, current RL agent policy at time step t), current hyperparameter for the RL agent at time step t, performance achieved with the current trained policy using current hyperparameters and current state of the trained RL agent)>. A total of N (e.g., N>0) tuning experiences or sessions may be collected, each of length T, from different environments and reinforcement learning (RL) agents, resulting in a total of N*T transition tuples. Any conventional or other hyperparameter tuning techniques or models may be utilized to generate the tuning experiences or sessions (e.g., population based training (PBT), population based bandits (PBB), Bayesian optimization (BayesOpt), etc.).

Machine learning tuning code 200 generates one or more rollouts from each environment and reinforcement learning (RL) agent observed for generating the tuning experiences. The rollouts correspond to different environment/RL agent pairs used by the hyperparameter tuning techniques during collection of the tuning experiences. The rollouts represent decision paths (or actions) taken by an RL agent in an environment, and include the state of an RL agent, the action, and the reward. The rollouts (or episodes) are collected from the tuning experiences by using interaction of an RL agent with the environment for which that RL agent is trained. Each episode corresponds to a set of state, action, and reward from a first time step until an end of the episode (e.g., either reach a terminal state or a maximum number of time steps per episode). The rollouts represent the state of the RL agents and the dynamics of the environments (from the tuning experiences). The rollouts are used to train a self-consistent autoencoder to generate concise encodings for each rollout (or episode) at operation 310. Each encoding contains information about the RL agent and the environment used to generate the rollout.

Once the autoencoder is trained, for each environment and reinforcement learning (RL) agent pair in the tuning experiences, one or more rollouts are sampled and subsequently encoded using the trained autoencoder. The rollouts are preferably the same type of rollouts used to train the autoencoder, and may be selected in various manners (e.g., the rollouts that achieve a highest cumulative reward, the rollouts that have cumulative rewards at various percentiles, etc.). For example, the encodings may be compressed by ranking the encodings based on the total rewards observed in the rollouts. Encodings of certain quartiles (e.g., 0, 25, 50, 75, 100, etc.) of a rollout may be selected and concatenated to obtain a resulting or final encoding for a given environment and reinforcement learning (RL) agent.

Machine learning tuning code 200 preprocesses the data at operation 315. For example, a new dataset is generated by replacing the environment and the reinforcement learning (RL) agent in every transition tuple (or tuning experience) with the final encoding. The resulting dataset is a batch of tuning trajectories, where each trajectory includes T (or one or more) tuples (corresponding to a time step t) indicating the resulting encoding, meta-data, hyperparameters for training, and performance achieved. The tuples may be of the form <(final encoding and meta-data, hyperparameters to train with, performance achieved)>. The meta-data may represent any additional information about the current stage of the RL agent and the environment. Further, T may represent the number of times the hyperparameter configurations are selected during training of an RL agent.

Machine learning tuning code 200 trains a meta-tuning agent (e.g., a decision transformer, etc.) at operation 320. The tuning experiences are used to train the meta-tuning agent. By way of example, the meta-tuning agent may be a sequential decision-transformer model that receives as input the state of the reinforcement learning (RL) agent, hyperparameters used to train the RL agent, and the reward or performance of the RL agent and produces hyperparameters for training the RL agent for a quantity of successive iterations. The state of the meta-tuning agent is a vector representing information about the RL agent (RL technique), information about the environment, and a current training stage of the RL agent (iteration id, current performance). The action of the meta-tuning agent is a real-valued vector representing the hyperparameter configurations that should be used to train the current RL agent for a quantity of successive iterations. The reward signal is the performance of the RL agent after training with the given configuration of hyperparameters.

The meta-tuning agent is trained using the modified tuning experience dataset with encodings (e.g., transition tuples of the tuning experiences modified with the final encoding as described above) as an offline reinforcement learning (RL) setting. Each episode includes T time steps, where each time step, t, includes a state (e.g., final encoding and meta-data), an action (e.g., configuration/hyperparameters used to train the RL agent), and a reward (e.g., agent performance at the end of training). The meta-tuning agent is trained using any conventional or other offline RL technique until the RL agent achieves maximum performance on a test set of RL agents and environments.

The state space for the offline RL setting should be carefully defined and capture a current state of the trained RL agent, a resulting policy, and the environment on which the RL agent is training. Since directly feeding an environment and policy of an RL agent to a model becomes infeasible, encodings are used as described herein.

Machine learning tuning code 200 tests or evaluates the meta-tuning agent at operation 325. The meta-tuning agent predicts a next hyperparameter configuration, and the RL agent is tuned with the predicted hyperparameter configuration for K (one or more) successive iterations. This process is repeated to attain a maximum performance by the RL agent. When the RL agent does not achieve an acceptable maximum performance after a period of time or number of iterations (e.g., performance satisfies a threshold, etc.), the meta-tuning agent may be re-trained in substantially the same manner described above.

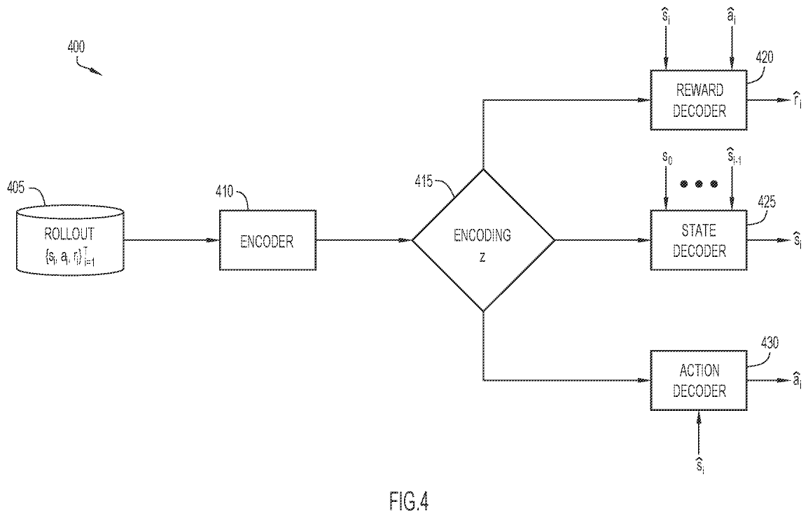

A method 400 of encoding rollouts of environments and reinforcement learning (RL) agents according to an embodiment of the present invention is illustrated in FIG. 4. This may be used for operations 310 and/or 315 of FIG. 3. Initially, directly feeding an environment and policy of an RL agent to a model becomes infeasible. In order to succinctly represent a given environment and an RL agent policy, rollouts of the RL agent in the environment are employed. However, rollouts of a policy may be very large in length. Accordingly, rollouts are sampled using different RL agents in different environments to train an autoencoder to generate a meaningful and concise encoding for any given rollout.

The autoencoder may be implemented by any conventional or other autoencoder (e.g., a variational long short-term memory (LSTM) autoencoder, a long short-term memory (LSTM) autoencoder, a self-consistent trajectory autoencoder, identity autoencoder, etc.) that may include any conventional or other machine learning models (e.g., mathematical/statistical, classifiers, feed-forward, recurrent, convolutional, deep learning, or other neural networks, etc.) for encoding rollouts. For example, the autoencoder may include an identity encoder that returns a complete trajectory as an encoding, or an encoder that extracts and concatenates various statistics from the trajectories.

By way of example, an autoencoder architecture includes an encoder network (e.g., encoder 410) and a decoder network (e.g., reward decoder 420, state decoder 425, and action decoder 430). The encoder network (or encoder 410) produces an initial encoding for a rollout at operation 415. The initial encoding is processed by the decoder network (or reward decoder 420, state decoder 425, and action decoder 430) to produce a concise encoding (e.g., length M, where M>0) for the rollout that captures information about the environment dynamics and the policy.

The autoencoder is trained by using information (e.g., environment and reinforcement learning (RL) agent (representing the state), hyperparameters (representing the action), performance of the RL agent (representing the reward)) from the rollouts generated from the dataset of tuning experiences described above. The encoded output (e.g., encoded state, action, and reward) is used to reconstruct the input (or state, action, and reward of the rollout), and the difference between the actual input and reconstructed input is used to adjust the autoencoder during training. Any conventional or other training techniques may be employed based on the type of machine learning model employed (e.g., backpropagation for neural networks, etc.). Since the initial encoding incudes lower dimensions, the training enables the initial encoding to identify correlated features. The decoder network generates the output based on the correlated features of the initial encoding, thereby reducing dimensions while maintaining relevant information.

Once the autoencoder is trained, one or more rollouts 405 are generated for each environment/reinforcement learning (RL) agent pair in the tuning experiences to produce encodings to generate training data for the meta-tuning agent. The rollouts 405 include environment and reinforcement learning (RL) agent (representing the state), hyperparameters (representing the action), and performance of the RL agent (representing the reward)). The observations, actions, and rewards in the rollouts are normalized using mean observations, actions, and rewards of the environment before being provided to the autoencoder. The encoder network (or encoder 410) receives a rollout 405 corresponding to an episode. The episode of the rollout includes a series of T (T>0) time steps, i, each including a state, si (corresponding to the environment and RL agent at time step i), an action aᵢ (corresponding to hyperparameters employed at time step i), and a reward, rᵢ (corresponding to a performance metric for the RL agent at time step i). The autoencoder produces an initial encoding, z, for the time steps of the rollout or episode at operation 415. The decoder network produces the encoding for the rollout or episode (encoded state, action, and reward) based on the initial encoding of the time steps. For example, state decoder 425 produces an encoded state for a current time step based on an initial state, so, and encoded states for any prior time steps. Action decoder 430 produces an encoded action based on a current encoded state, and reward decoder 420 produces an encoded reward based on the current encoded state and the current encoded action. The encoded state, action, and reward form the final time step represent the resulting encoding for the rollout or episode (based on the information from time steps of the rollout or episode). The decoder network basically attempts to recreate or reproduce the input rollout from the initial encoding. The initial and resulting encodings represent numerical values (or vectors) corresponding to features of the state, action, and reward.

Encodings are generated for each rollout or episode of an environment/reinforcement learning (RL) pair. In order to compress the encodings, the encodings of the rollouts may be ranked with respect to the total rewards of the rollouts. Encodings of quantiles of the ranked rollouts (e.g., 0, 25, 50, 75, 100) are extracted and concatenated to obtain a final encoding (of length 5 M based on the 5 encodings from the quartiles each of length M) that sufficiently represents the policy (or RL agent) and the environment for an environment/RL agent pair. The autoencoder may also be further fined tuned in conjunction with the meta-tuning agent to capture additional biases in encoding patterns that can improve prediction accuracy of the meta-tuning agent.

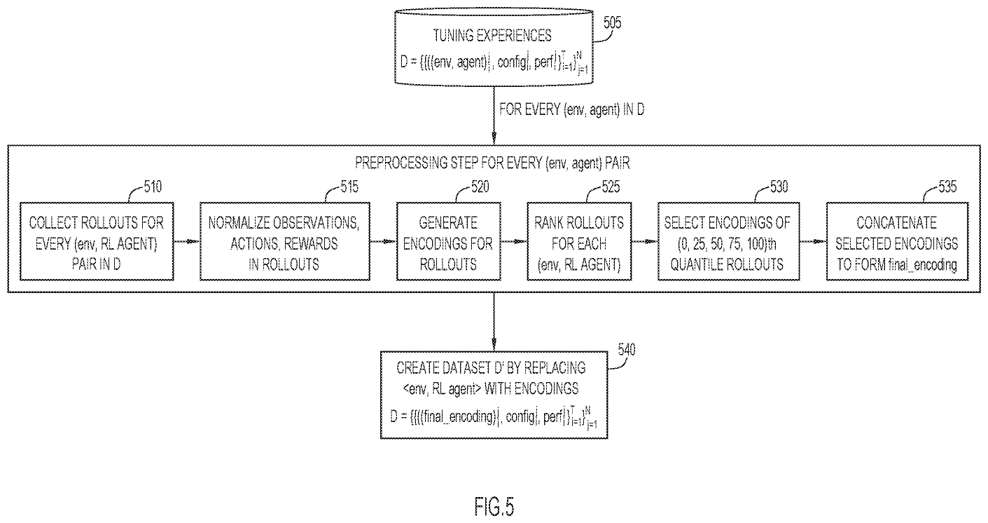

A method 500 of preprocessing rollouts for training a meta-tuning agent to produce hyperparameters for training a reinforcement learning (RL) agent according to an embodiment of the present invention is illustrated in FIG. 5. This may correspond to operation 315 of FIG. 3. Initially, tuning experiences 505 are collected as described above. The tuning experiences include episodes represented by a series of T time steps, i, with each time step, i, including the environment, reinforcement learning (RL) agent, configuration/hyperparameters, and performance of the RL agent as described above.

One or more rollouts or episodes are generated or collected for each environment/reinforcement learning (RL) agent pair in the tuning experiences at operation 510 in substantially the same manner described above. The observations (states), actions, and rewards of the rollouts for each environment/RL agent pair are normalized at operation 515. For example, the normalization may be accomplished using mean observations, actions, and rewards of the environment. Encodings are generated for the rollouts by the trained autoencoder at operation 520, and encodings of rollouts for each environment/RL agent pair are ranked based on performance of the RL agent at operation 525. Encodings of rollouts are selected for each environment/RL agent pair at operation 530. The rollouts may be selected in various manners (e.g., the rollouts that achieve a highest cumulative reward, the rollouts that have cumulative rewards at various percentiles, etc.). For example, the encodings may be compressed by ranking the encodings based on the total rewards observed in the rollouts. Encodings of certain quartiles (e.g., 0, 25, 50, 75, 100, etc.) of a rollout may be selected. In this example case, 5 encodings may be selected based on an encoding at each quantile (e.g., 0, 25, 50, 75, and 100). Alternatively, encodings of all rollout trajectories for an environment/RL agent pair may be selected and used. The selected encodings for each environment/RL agent pair are concatenated to form a final encoding for that pair at operation 535.

Once the final encodings are determined for each of the environment/reinforcement learning (RL) agent pairs in the tuning experiences, a new dataset (e.g., D′ as shown in FIG. 5) is generated at operation 540 with N (one or more) trajectories, where each trajectory comprises T (one or more) tuples, preferably of the form <(final encoding and meta-data, hyperparameter, performance achieved)>. The meta-data includes additional information about the environment and state of the RL agent, such as current iteration id, algorithm id, and current performance of the agent. In other words, the environment and RL agent pair of a transition tuple are replaced with the corresponding final encoding for that pair. This enables the meta-tuning agent to be trained based on the policy (or behavior) of a reinforcement learning (RL) agent in a corresponding environment and the stage of training/tuning.

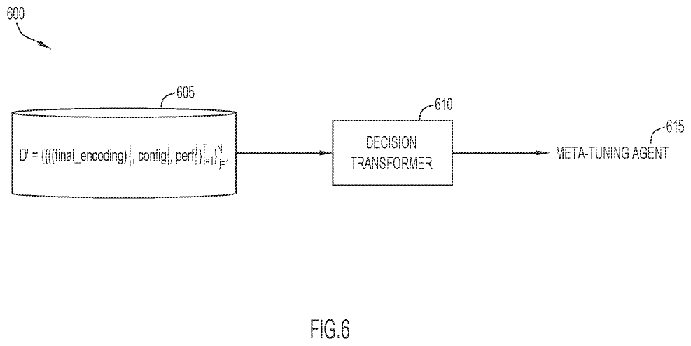

A method 600 of using preprocessed rollouts to train a meta-tuning agent according to an embodiment of the present invention is illustrated in FIG. 6. This may correspond to operation 320 of FIG. 3. Initially, a dataset 605 (e.g., D′ as shown in FIG. 6) is generated as described above, and includes N (one or more) trajectories (or episodes), where each trajectory (or episode) comprises T (one or more) tuples (or time steps, i), preferably of the form <(final encoding and meta-data, hyperparameter, performance achieved). The meta-data includes additional information about the environment and state of the RL agent, such as current iteration id, algorithm id, and current performance of the agent.

The meta-data and the final encoding represent the state of the meta-tuning agent, the hyperparameters represent the action of the meta-tuning agent, and the performance achieved is the reward signal given to the meta-tuning agent.

Dataset 605 is applied to a decision-transformer machine learning model 610 to train the decision-transformer model offline to predict effective hyperparameters for reinforcement learning (RL) agents in the dataset with high accuracy. The decision-transformer model uses a sequence modeling algorithm (or transformer) that produces future actions to attain a desired return based on the desired return, prior states, and actions. During training, the decision-transformer model receives data from dataset 605 for a prior time and produces an action (or hyperparameters) for a next time. Since the dataset 605 is pre-computed, the action at the next time is known in the dataset and can be compared to the action produced by decision-transformer model 610. For example, dataset 605 may include states, rewards, and actions for times t₁-t₁₀. When decision-transformer model receives corresponding data for time t₁ to produce an action for a time t₂, the action for time t₂ is already known and in the dataset 605 (which includes data for times t₁-t₁₀). The difference between the known and produced actions may be used to adjust the decision-transformer model during training. The decision-transformer model may be trained for any desired quantity of iterations (e.g., 200-250, etc.) and/or until a training loss does not sufficiently improve (e.g., satisfies a training threshold, etc.). Any conventional or other training techniques may be used to train decision-transformer model 610 (e.g., state of the art (SOTA) offline machine learning algorithm, etc.).

The trained decision-transformer model implements a meta-tuning agent 615. However, any conventional or other machine learning models (e.g., mathematical/statistical, classifiers, feed-forward, recurrent, convolutional, deep learning, or other neural networks, etc.) may be employed for the meta-tuning agent.

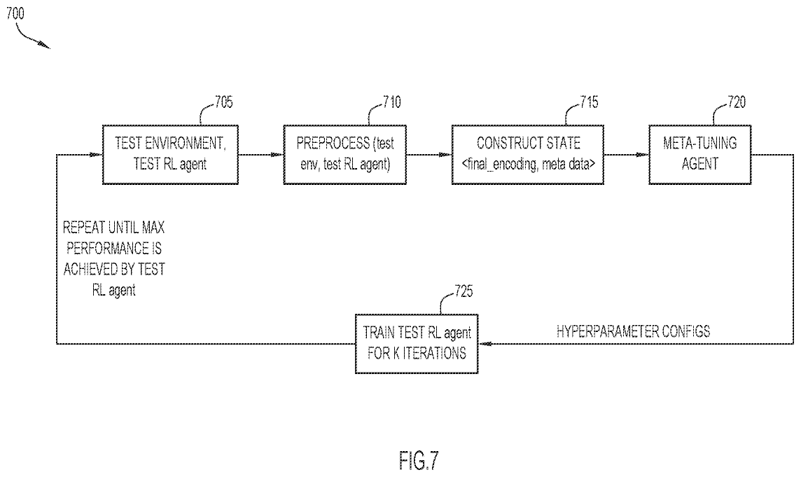

A method 700 of evaluating a meta-tuning agent generating hyperparameters for reinforcement learning (RL) according to an embodiment of the present invention is illustrated in FIG. 7. This may correspond to operation 325 of FIG. 3. Initially, multiple rollouts for a new environment (and reinforcement learning (RL) agents) are generated using a random policy, and mean observations, actions, and rewards of the environment are determined. These rollouts are collected by using RL agents to interact with the new environment in substantially the same manner described above. In order for the meta-tuning agent to generate the next hyperparameters, the input to the meta-tuning agent is formed which requires generating encodings of rollouts that represent a current state of an RL agent being trained. The rollouts may be selected in substantially the same manner described above (e.g., quantiles, etc.).

One or more rollouts are produced or obtained for a current RL agent at operation 705, and an encoding is generated for the environment and the RL agent at operation 710 in substantially the same manner described above for generating the dataset for training the meta-tuning agent. A state vector is generated at operation 715 by concatenating the encoding with meta-data generated for the state of the RL agent and the environment. The meta-tuning agent predicts a next hyperparameter configuration (of one or more hyperparameters) for the state vector at operation 720, and the RL agent is tuned (or trained) based on the predicted hyperparameter configuration for K (one or more) successive iterations at operation 725. The tuning may be performed in accordance with one or more parameters (e.g., number of iterations, etc.), and may use any conventional or other RL training techniques. For example, the parameters may indicate a number of iterations (or time steps), where the hyperparameters may be determined or tuned by the meta-tuning agent at a certain interval (or quantity of time steps) (e.g., tune every 2,000 steps of 10,000 iterations, etc.). By way of example, a proximal policy optimization (PPO) RL agent may be trained for 100,000 time steps in which the meta-tuning agent generates new hyperparameters every 3,333 time steps. This process is repeated to attain a maximum performance by the RL agent. When the RL agent does not achieve an acceptable maximum performance after a period of time or number of iterations (e.g., performance satisfies a threshold, etc.), the meta-tuning agent may be re-trained in substantially the same manner described above.

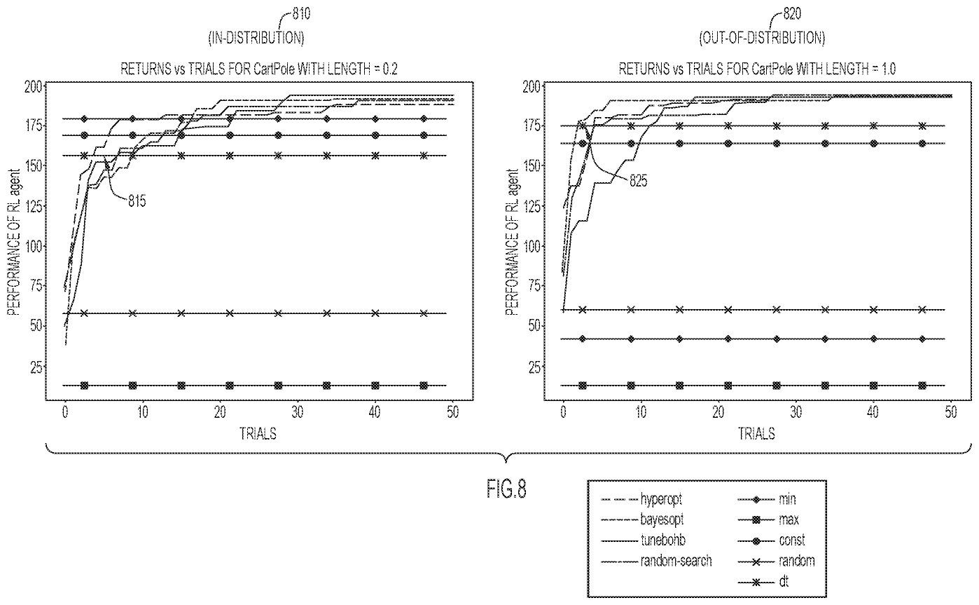

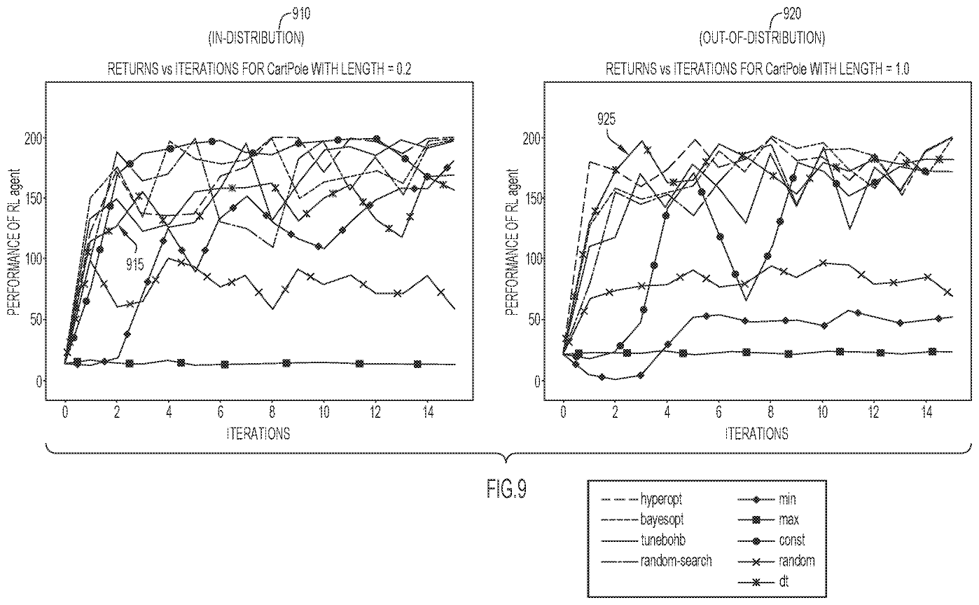

Graphical illustrations of results of hyperparameter tuning by an embodiment of the present invention relative to conventional techniques are illustrated in FIGS. 8 and 9. Initially, an environment for the comparisons included 12 variants of CartPole training environments (varying length from 0.1 to 1.5), 6,846 training trajectories, 4 hyperparameters (learning rate, generalized advantage estimation (GAE) lambda, clip range, and entropy coefficient for loss calculation), a stable-baselines proximal policy optimization (PPO) algorithm, a population based training (PBT) data collection algorithm, and 2 training environments (In-Distribution Task: CartPole lengths—0.2, 0.4, 0.8; and Out-of-Distribution Task: CartPole lengths—0.5, 1.0, 1.4). The conventional techniques or baselines included Random-Search (random-search as viewed in FIGS. 8 and 9), HyperOpt (hyperopt as viewed in FIGS. 8 and 9), BayesOpt (bayesopt as viewed in FIGS. 8 and 9), TuneBOHP (tunebohb as viewed in FIGS. 8 and 9), Min (min as viewed in FIGS. 8 and 9), Max (max as viewed in FIGS. 8 and 9), Const (tuned) (const as viewed in FIGS. 8 and 9), and Random (random as viewed in FIGS. 8 and 9). Results of these techniques are plotted against an embodiment of the present invention (dt as viewed in FIGS. 8 and 9).

FIG. 8 illustrates plots 810, 820 of performance of a reinforcement learning (RL) agent relative to a quantity of trials. Plot 810 corresponds to an in-distribution task (e.g., data included in the training data), while plot 820 corresponds to an out-of-distribution task (e.g., data external of the training data). Plots 810, 820 demonstrate that the techniques HyperOpt, BayesOpt, Random-Search, and TuneBOHB each need a certain number of trials (1 trial=10⁵ time steps) to reach an embodiment of the present invention (e.g., shown by arrows 815 and 825).

FIG. 9 illustrates plots 910, 920 of performance of a reinforcement learning (RL) agent relative to a quantity of iterations. Plot 910 corresponds to an in-distribution task (e.g., data included in the training data), while plot 920 corresponds to an out-of-distribution task (e.g., data external of the training data). Plots 910, 920 demonstrate that the embodiment of the present invention (e.g., shown by arrows 915 and 925) outperforms the random, min, and max techniques or baselines, but achieves almost the same performance as the best trial of Bayesopt, Hyperopt and Tunebohb (200 trials) with no additional training.

Accordingly, present invention embodiments provide several technical advantages. For example, present invention embodiments enable faster training of reinforcement learning (RL) agents, thereby improving computer performance by utilizing reduced processing and storage. Further, the present invention embodiments conserve processing and storage by using fewer trials and iterations to attain better or similar performance (for RL agents).

It will be appreciated that the embodiments described above and illustrated in the drawings represent only a few of the many ways of implementing embodiments for reinforcement machine learning with hyperparameter tuning.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., machine learning tuning code, etc.) may be implemented in any desired computer language and could be developed by one of ordinary skill in the computer arts based on the functional descriptions contained in the specification and flowcharts (and/or flow diagrams) illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts (and/or flow diagrams) may be modified in any manner that accomplishes the functions described herein. In addition, the functions in the flowcharts (and/or flow diagrams) or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user.

The present invention embodiments are not limited to the specific tasks or algorithms described above, but may be utilized for determining hyperparameters for any types of machine learning agents or models for any environments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of training a reinforcement learning agent comprising:
training, via at least one processor, a machine learning model based on training data to generate a set of hyperparameters for training the reinforcement learning agent, wherein the training data includes encoded information from hyperparameter tuning sessions for a plurality of different reinforcement learning environments and reinforcement learning agents;
determining, by the machine learning model, the set of hyperparameters for training the reinforcement learning agent;
training, via the at least one processor, the reinforcement learning agent according to the set of hyperparameters; and
adjusting, by the machine learning model, the set of hyperparameters based on information from testing of the reinforcement learning agent.

2. The method of claim 1, wherein the machine learning model includes a decision-transformer.

3. The method of claim 1, wherein training the machine learning model further comprises:
producing encodings of a set of rollouts from the hyperparameter tuning sessions by a second machine learning model to produce the training data, wherein the set of rollouts indicates policies of corresponding reinforcement learning agents and environment dynamics for the hyperparameter tuning sessions.

4. The method of claim 3, wherein the second machine learning model includes an autoencoder.

5. The method of claim 3, wherein training the machine learning model further comprises:
determining rollouts from the hyperparameter tuning sessions, wherein the determined rollouts indicate policies of the reinforcement learning agents with respect to the environments; and
training the second machine learning model with the determined rollouts to produce the encodings.

6. The method of claim 3, wherein training the machine learning model further comprises:
ranking the encodings for a hyperparameter tuning session based on rewards observed in the set of rollouts for the hyperparameter tuning session; and
concatenating encodings of selected rollouts of the hyperparameter tuning session to produce a resulting encoding for the training data for the hyperparameter tuning session.

7. The method of claim 1, wherein training the machine learning model further comprises:
generating a series of rollouts for a new environment;
determining encodings for a selected set of rollouts by a second machine learning model;
predicting a set of hyperparameters for a corresponding reinforcement learning agent by the machine learning model based on the encodings; and
evaluating the machine learning model based on performance of the corresponding reinforcement learning agent after training according to the predicted set of hyperparameters.

8. A system for training a reinforcement learning agent comprising:
one or more memories; and
at least one processor coupled to the one or more memories, and configured to:
train a machine learning model based on training data to generate a set of hyperparameters for training the reinforcement learning agent, wherein the training data includes encoded information from hyperparameter tuning sessions for a plurality of different reinforcement learning environments and reinforcement learning agents;
determine, by the machine learning model, the set of hyperparameters for training the reinforcement learning agent;
train the reinforcement learning agent according to the set of hyperparameters; and
adjust, by the machine learning model, the set of hyperparameters based on information from testing of the reinforcement learning agent.

9. The system of claim 8, wherein training the machine learning model further comprises:
producing encodings of a set of rollouts from the hyperparameter tuning sessions by a second machine learning model to produce the training data, wherein the set of rollouts indicates policies of corresponding reinforcement learning agents and environment dynamics for the hyperparameter tuning sessions.

10. The system of claim 9, wherein the machine learning model includes a decision-transformer, and the second machine learning model includes an autoencoder.

11. The system of claim 9, wherein training the machine learning model further comprises:
determining rollouts from the hyperparameter tuning sessions, wherein the determined rollouts indicate policies of the reinforcement learning agents with respect to the environments; and
training the second machine learning model with the determined rollouts to produce the encodings.

12. The system of claim 9, wherein training the machine learning model further comprises:
ranking the encodings for a hyperparameter tuning session based on rewards observed in the set of rollouts for the hyperparameter tuning session; and
concatenating encodings of selected rollouts of the hyperparameter tuning session to produce a resulting encoding for the training data for the hyperparameter tuning session.

13. The system of claim 8, wherein training the machine learning model further comprises:
generating a series of rollouts for a new environment;
determining encodings for a selected set of rollouts by a second machine learning model;
predicting a set of hyperparameters for a corresponding reinforcement learning agent by the machine learning model based on the encodings; and
evaluating the machine learning model based on performance of the corresponding reinforcement learning agent after training according to the predicted set of hyperparameters.

14. A computer program product for training a reinforcement learning agent, the computer program product comprising one or more computer readable storage media having program instructions collectively stored on the one or more computer readable storage media, the program instructions executable by at least one processor to cause the at least one processor to:
train a machine learning model based on training data to generate a set of hyperparameters for training the reinforcement learning agent, wherein the training data includes encoded information from hyperparameter tuning sessions for a plurality of different reinforcement learning environments and reinforcement learning agents;
determine, by the machine learning model, the set of hyperparameters for training the reinforcement learning agent;
train the reinforcement learning agent according to the set of hyperparameters; and
adjust, by the machine learning model, the set of hyperparameters based on information from testing of the reinforcement learning agent.

15. The computer program product of claim 14, wherein the machine learning model includes a decision-transformer.

16. The computer program product of claim 14, wherein training the machine learning model further comprises:
producing encodings of a set of rollouts from the hyperparameter tuning sessions by a second machine learning model to produce the training data, wherein the set of rollouts indicates policies of corresponding reinforcement learning agents and environment dynamics for the hyperparameter tuning sessions.

17. The computer program product of claim 16, wherein the second machine learning model includes an autoencoder.

18. The computer program product of claim 16, wherein training the machine learning model further comprises:
determining rollouts from the hyperparameter tuning sessions, wherein the determined rollouts indicate policies of the reinforcement learning agents with respect to the environments; and
training the second machine learning model with the determined rollouts to produce the encodings.

19. The computer program product of claim 16, wherein training the machine learning model further comprises:
ranking the encodings for a hyperparameter tuning session based on rewards observed in the set of rollouts for the hyperparameter tuning session; and
concatenating encodings of selected rollouts of the hyperparameter tuning session to produce a resulting encoding for the training data for the hyperparameter tuning session.

20. The computer program product of claim 14, wherein training the machine learning model further comprises:
generating a series of rollouts for a new environment;
determining encodings for a selected set of rollouts by a second machine learning model;
predicting a set of hyperparameters for a corresponding reinforcement learning agent by the machine learning model based on the encodings; and
evaluating the machine learning model based on performance of the corresponding reinforcement learning agent after training according to the predicted set of hyperparameters.
